(19) United States
(12) Patent Application Publication
(10) Pub. No.: US 2024/0001839 A1
(43) Pub. Date: Jan. 4, 2024

(54) Decorative Vehicle Element Having a Contour Light

(71) Applicant: Bayerische Motoren Werke Aktiengesellschaft, Muenchen (DE)

(72) Inventors: Jon BUSTO, Liria (ES); Sergio PILES, Liria (ES)

(21) Appl. No.: 18/039,367

(22) PCT Filed: Dec. 6, 2021
(86) PCT No.: PCT/EP2021/084304

§ 371 Date: May 30, 2023

(30) Foreign Application Priority Data
Dec. 17, 2020 (DE) 10 2020 133 876.7

(51) Int. Cl. B60Q 1/28; F21V 8/00; B60R 13/04; B29D 11/00

(52) U.S. Cl. CPC B60Q 1/28; G02B 6/0091; B60R 13/04; B29K 2995/0029; B29K 2995/0003; B29K 2995/0026; B29D 11/00663

(57) ABSTRACT

A decorative vehicle element has a contour light. The decorative element is produced as an integrally bonded composite from at least two plastics components in a multi-component injection molding process. A first plastics component consists of a material which can be galvanically coated or lacquered and forms the decorative element, and a second plastics component consists of a transparent or translucent and galvanically inert material and forms a contour light region through which light from an optical fiber element can pass. The second plastics component is located on a rear face of the first plastics component adjoining this face and partially covers the rear face of the first plastics component. An element component produced from the first plastics component performs fastening and fixing of the optical fiber located on the rear face.

### BACKGROUND AND SUMMARY OF THE INVENTION

The invention relates to a galvanically decorated vehicle decoration part having a contour light, which may be used with an optical waveguide element mounted therein for ambient lighting, for example of a radiator grill, in vehicles.

DE 10 2016 100 629 A1 discloses a galvanically decorated decoration element having a contour light, which is made from at least two plastics components in a materially bonded composite. A first of the plastics components is galvanizable and forms the decoration element. At least a second of the plastics components is galvanically inert, passes uncoated and unmodified through the galvanic process and constitutes the contour light region through which light can pass. The part section made from the second plastics component encompasses the contour light region through which light can pass and the rear side of the part section of the first plastics component, this having a positive effect on the warping of the components. Fastening elements of the decoration element, such as hooks or snap elements, are formed from the non-galvanizable component. The fastening or fixing for a lighting device fitted on the rear side and the fastening of the decoration strip on a carrier are carried out on the second, non-galvanizable component.

It is an object of the present invention to provide a vehicle decoration part having a contour light, which can be constructed more compactly in comparison with the ones in the prior art and with which sophisticated contour light solutions can be produced with a high optical quality. It is a further object to provide a method for producing a vehicle decoration part having a contour light, with which a compact vehicle decoration part with high optical quality can be produced in a simple, reliable and economical way.

These objects are achieved by a vehicle decoration part and by a method according to the claimed invention.

A vehicle decoration part having a contour light is provided, which is constructed more compactly in comparison with the prior art, can be made in a composite and has an esthetically attractive visual appearance. This is made possible by the fact that the decoration part is produced as a materially bonded composite from at least two plastics components in a multicomponent injection-molding method. A first plastics component of the at least two plastics components consists of a material which can be galvanically coated or lacquered and forms the decoration part. A second plastics component of the at least two plastics components consists of a transparent or translucent and galvanically inert material and forms a contour light region through which light from an optical waveguide element can pass. The second plastics component is arranged on a rear side of the first plastics component, adjacent to the latter, and partially covers the rear side of the first plastics component. The vehicle decoration part is distinguished in that a part component produced from the first plastics component performs fastening and fixing of the optical waveguide element arranged on the rear side.

Because the second plastics component only partially covers the rear side of the first plastics component consisting of the material which can be galvanically coated or lacquered, the fastening and fixing of the optical waveguide element arranged on the rear side can be performed by the part component produced from the first plastics component. On the one hand this leads to increased available space on the rear side of the decoration part, since the second plastics component only partially covers the rear side of the first plastics component. This allows simple manufacture of the decoration part since the space available for tools is increased. Since the piece performing the fixing of the optical waveguide element furthermore does not need to be fed through the second plastics component, manufacture is also simplified in respect of demolding properties. What is more, sink marks which impair the visual appearance may reliably be avoided. In addition, the degree of freedom for fastening and fixing the optical waveguide element is increased. Since no elements of the second plastics component are used for the fastening of the decoration part, the risk of optical defects in the contour light region due to mechanical deformations is less. The optical quality may therefore be ensured better.

The first plastics component may, for example, consist of a copolymer containing butadiene. The second plastics component may consist of an amorphous polyimide (PA) which is transparent or translucent, or scatters light. In particular, a polycarbonate (PC) may be used. Alternatively, polymethyl methacrylate (PMMA) or cyclo-olefin copolymers (COC) may be envisioned as materials. Parts consisting of polyamides (PA) or polycarbonates (PC) allow light to pass through, so that the desired contour light solutions may be achieved with them.

In one expedient configuration, the fixing of the optical waveguide element is carried out by way of at least one web pointing in the direction of the rear side. Besides its mechanical function, the at least one web pointing in the direction of the rear side of the decoration part may also fulfill a light guiding function. For this purpose, the surface of the at least one web may be provided with a corresponding reflective surface. This may, for example, be the material applied onto the first plastics component in the scope of a galvanic or lacquering process.

According to another expedient configuration, a material transition of the first plastics component and the second plastics component takes place continuously and without a wall thickness discontinuity in the region of a material interface formed between the part component produced from the first plastics component and a part component produced from the second plastics component. The continuous material transition makes it possible to produce a materially bonded composite with an approximately continuous thickness in the region of the material interface, so that no material distortions or visually perceptible sink marks occur.

It is furthermore expedient for a step having a height of at least 0.5 mm to be produced in the front-side region of the material interface. This ensures that a defined material transition takes place, coating of the first plastics component being made possible precisely as far as the material interface. This also allows a high optical quality.

According to another expedient configuration, the part component produced from the first plastics component is provided on the front side with a protective layer composite consisting of at least one lacquer layer. In this way, the optical properties can be adjusted in a desired way and mechanical protection can likewise be provided. The decoration part may therefore be used not only as a vehicle interior part but also as an exterior part.

According to another expedient configuration, alternatively or in addition the contour light region is provided on the front side with a protective layer composite consisting of at least one lacquer layer. In this case as well, a protective layer adapted to a very wide variety of ambient conditions may in particular be provided by the protective layer composite.

According to another expedient configuration, a first lacquer layer consists of an adhesion-promoting transparent or colored translucent material, which is applied without a further interlayer onto the part component produced from the first plastics component and/or onto the contour light region. By way of the first lacquer layer, particular optical effects may be achieved, for example coloration or metallization.

Expediently, a second lacquer layer consists of a transparent as well as mechanically and chemically resistant material. In one variant, the second lacquer layer may be applied directly onto the first lacquer layer. In another variant, the second lacquer layer may be applied directly, that is to say without the first layer, onto the part component produced from the first plastics component and/or onto the contour light region. The second lacquer layer provides protective properties primarily adapted to outside ambient conditions.

According to another expedient configuration, the composite consisting of the part component produced from the first plastics component and the part component produced from the second plastics component is produced by an adhesive bond or a welded connection or a plug-in connection to an internal piece carrier. Such a connection at the same time allows sealing of the rear side of the vehicle decoration part relative to the internal piece carrier.

The invention furthermore provides a method for producing a vehicle decoration part having a contour light of the type mentioned above according to one or more configuration variants. In the scope of the production, the following steps are carried out.

In a first step a), a connection is established between a first plastics component consisting of a material which can be galvanically coated or lacquered and the second plastics component consisting of a transparent or translucent and galvanically inert material in the multicomponent injection-molding method. Following this, in a step b), the galvanizing or lacquering of the composite produced in step a) is carried out, a galvanic layer or lacquer layer being formed only on the first plastics component. The regions formed by the second, galvanically inert plastics component remain free, so that the contour light region through which light can pass is obtained. In a step c), a front-side surface treatment of the galvanized or lacquered composite is carried out.

The method according to embodiments of the invention provides a vehicle decoration part having a high surface quality and at the same time a high strength in relation to wear and environmental influences.

According to one expedient configuration, the surface treatment comprises an activation of the front-side surface of the composite in a plasma system with a low-pressure plasma. Preferably, the surface treatment comprises activation of the front-side surface in the plasma system with a reduced pressure of 0.15 mbar and water vapor as a process gas.

It is furthermore expedient for the surface treatment to comprise providing the part component, produced from the first plastics component, of the galvanized or lacquered composite with a protective layer composite, consisting of at least one lacquer layer, on the front side. In particular, alternatively or in addition, the surface treatment comprises providing the contour light region with the protective layer composite, consisting of at least one lacquer layer, on the front side.

Expediently, a first lacquer layer consisting of an adhesion-promoting transparent or colored translucent material is applied on the front side onto the galvanized or lacquered composite, specifically without a further interlayer onto the part component produced from the first plastics component and/or onto the contour light region. Alternatively or in addition, a lacquer layer consisting of a transparent as well as mechanically and chemically resistant material is applied on the front side onto the galvanized or lacquered composite.

The invention will be described in more detail below with the aid of an exemplary embodiment with reference to the FIGURE.

### BRIEF DESCRIPTION OF THE DRAWING

FIG. 1 shows a section through a vehicle decoration part according to an embodiment of the invention having a contour light, which is configured for example as a border of a radiator grill as an external part.

### DETAILED DESCRIPTION OF THE DRAWING

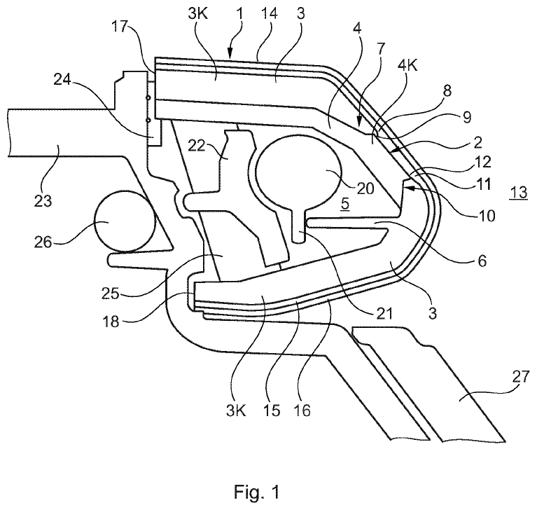

The vehicle decoration part shown in FIG. 1 constitutes a galvanically decorated decoration part 1 and is made from two plastics components 3K, 4K in a materially bonded composite. The connection of the plastics components 3K, 4K is consequently held together by atomic or molecular forces. The connection is not releasable. It is produced in the known multicomponent injection-molding method.

One of the two plastics components, which will be referred to below as the first plastics component 3K, consists of a material which can be galvanized or lacquered. It forms the decoration part 1. In the exemplary embodiment, the first plastics component 3K consists, for example, of a copolymer containing butadiene. Other materials may likewise be used so long as they can be galvanized or lacquered.

The other plastics component, which will be referred to below as the second plastics component 4K, is galvanically inert. In the scope of embodiments of the present invention, this is intended to mean that the second plastics component 4K passes uncoated and unmodified through the galvanic or lacquering process. During the galvanic or lacquering process, no metallic deposits or coats are therefore formed on the second plastics component 4K.

A part component 4 produced from the second plastics component 4K forms a contour light region 2 through which light can pass. In the exemplary embodiment, the second plastics component 4K encompasses a part of a rear-side part section of the first plastics component 3K. In the exemplary embodiment shown in FIG. 1, the second plastics component 4K forms the rear side of an upper section of a part component 3 produced from the first plastics component 3K, while a lower section of the part component 3 is not covered by the second plastics component 4K.

The second plastics component 4K is formed from an amorphous polyamide (PA) which is transparent or translucent, or scatters light. Preferably, the plastics component 4K consists of a polycarbonate (PC). Polymethyl methacrylate (PMMA) or cyclo-olefin copolymers (COC) may also be used.

In cross section, the decoration part 1 approximately describes the shape of a horizontally arranged “U”. Arranged on the rear side 5 of the decoration part, which may be regarded as the “interior” of the decoration part 1, there is an optical waveguide element 20. The optical waveguide element 20 is held, or fixed, by a part section of the lower section of the part component 3 produced from the first plastics component 3K. For this purpose, by way of example, a web 21 of the optical waveguide element 20 is brought into connection with the component section 6, configured as a web 6, of the part component 3. Provided further toward the rear, there is an optical waveguide holding element 22, which is fastened on a side facing away from the contour light 2 on an internal piece carrier 23 by way of a bonding agent, for example an adhesive. In order to provide a connection surface which is as large as possible, the optical waveguide holding element 22 has a section, pointing away from the contour light region 2, which protrudes through the seal 4, for example in the direction of the internal piece carrier 23.

Rear-side ends 17, 18 of the composite consisting of the part components 3 and 4 are connected to the internal piece carrier 23, and the connection 24 may preferably be provided by way of adhesive bonding or welding. Alternatively, a (releasable or nonreleasable) snap connection may be provided. By the connection 24, sealing (which is graphically represented schematically only at the rear-side end 17) may be carried out so that the optical waveguide element 20 enclosed between the decoration part 1 and the internal piece carrier 23 is hermetically isolated from environmental influences.

The internal piece carrier 23 is furthermore used to receive a cable 26 and for fastening a decoration grid 27, for example a radiator grill of the vehicle. The decoration part 1 then constitutes for example a border of the radiator grill or of the decoration grid 27, or is part of the radiator grill.

As already described above, the part component 3 produced from the first plastics component 3K is configured in the shape of a U. In the exemplary embodiment, the part component 4 produced from the second plastics component 4K is arranged merely on the upper section of the part component 3. Arranged on the lower portion of the part component 3, in particular without protruding through the part component 4, are the webs needed for fixing the optical waveguide element 20. In one modification, the part component 4 produced from the second plastics component 4K could be arranged only on the lower section of the part component 3. The webs needed for fixing the optical waveguide element 20 would then be arranged on the upper portion of the part component 3, in particular without protruding through the part component 4.

In order to obtain a flawless visual appearance on a front side 13 of the decoration part, in the region of a material interface 8, 11 which is formed between the part component 3 produced from the first plastics component 3K and the part component 4 produced from the second plastics component 4K, a material transition 7, 10 of the first plastics component 3K and the second plastics component 4K is produced in such a way that it is continuous and without a wall thickness discontinuity. Furthermore, a step 9, 12 having a height of at least 0.5 mm is respectively produced in the front-side region of the material interface 8, 11, so that material distortions can be avoided during the injection-molding process and, at the same time, clean coating of the first plastics component 3K in the galvanic or lacquering process is made possible.

The continuous material transition, taking place without a wall thickness discontinuity, is obtained by an approximately constant wall thickness of the composite piece.

Forming the webs used for the fixing on the lower section (in the exemplary embodiment) of the part component 3, on which none of the second plastics component 4K is provided, allows simple manufacture and in particular simple application of molds and demolding tools.

In the exemplary embodiment represented in FIG. 1, the decoration part 1 is provided on the front side with a protective layer composite 14 consisting of two lacquer layers 15, 16. In the exemplary embodiment, the protective layer composite 14 is applied both on the part component 3 produced from the first plastics component 3K and on the part component 4 produced from the second plastics component 4K, that is to say the contour light region 2. This is not compulsory, and the protective layer composite could instead be applied either only on the part component 3 or only on the part component 4.

The protective layer composite 14 comprises a first lacquer layer 15 consisting of an adhesion-promoting transparent or colored translucent material, which is applied without a further interlayer onto the part component 3 produced from the first plastics component 3K and onto the contour light region 2. By way of a colored translucent material, particular effects may be achieved. In particular, the part component 3 may for example be colorfully or mechanically colored. The second lacquer layer 16 consists of a transparent as well as mechanically and chemically resistant material, and forms the outermost layer of the protective layer composite 14.

The production of the decoration part according to embodiments of the invention is carried out in a manner known per se. First, a connection is established between the two plastics components 3K and 4K in the two-component injection-molding method. Following this, the galvanizing or lacquering is carried out, the galvanic or lacquer layer being deposited only on the first, galvanizable plastics component 3K. The regions (contour light regions) formed by the second, galvanically inert plastics component 4K remain free, so that the contour light region 2 through which light can pass is obtained. In this case, the contour light region 2 and the part region to be galvanized are geometrically configured in such a way that they build up the deposited layers in the galvanic process, or the lacquer layers in the lacquer application method, with sharp contours precisely as far as the material interface of the two plastics components 3K, 4K.

Since the vehicle decoration part is intended as an exterior component, a front-side surface treatment of the galvanized or lacquered composite is subsequently carried out. In this case, an activation of the front-side surface is carried out in a plasma system with a low-pressure plasma, in particular with a reduced pressure of 0.15 mbar and water vapor as a process gas. A protective layer composite, consisting of at least one lacquer layer 15, 16, is then applied. Preferably, the lacquer layer 15 is applied first as an adhesion-promoting layer, which is optionally carried out transparently or with a translucent coloration. After this, the lacquering with the second lacquer layer 16, which is transparent and constitutes the exterior surface, is carried out. It fulfills the requirements in respect of mechanical and chemical resistance.

### LIST OF REFERENCES

1 decoration part
2 contour light
3 part component produced from the first plastics component
3K first plastics component
4 part component produced from the second plastics component
4K second plastics component
5 rear side
6 fixing (web)
7 first material transition
8 first material interface
9 first step
10 second material transition
11 second material interface
12 first step
13 front side
14 protective layer composite
15 first lacquer layer
16 second lacquer layer
17 rear-side end of the composite consisting of the part components 3 and 4
18 rear-side end of the composite consisting of the part components 3 and 4
20 optical waveguide element
21 web of the optical waveguide element
22 optical waveguide holding element
23 internal piece carrier
24 seal
25 bonding agent
26 cable
27 decoration grid

1.-16. (canceled)

17. A vehicle decoration part comprising:
a contour light, wherein:
the decoration part is produced as a materially bonded composite from at least two plastics components in a multicomponent injection-molding method,
a first plastics component of the at least two plastics components consists of a material which can be galvanically coated or lacquered and forms the decoration part,
a second plastics component of the at least two plastics components consists of a transparent or translucent and galvanically inert material and forms a contour light region through which light from an optical waveguide element can pass,
the second plastics component is arranged on a rear side of the first plastics component, adjacent to the first plastics component, and partially covering the rear side of the first plastics component, and
a part component produced from the first plastics component performs fastening and fixing of the optical waveguide element arranged on the rear side.

18. The vehicle decoration part according to claim 17, wherein the fixing of the optical waveguide element is carried out by way of at least one web pointing in a direction of the rear side.

19. The vehicle decoration part according to claim 17, wherein a material transition of the first plastics component and the second plastics component takes place continuously and without a wall thickness discontinuity in a region of a material interface formed between the part component produced from the first plastics component and a part component produced from the second plastics component.

20. The vehicle decoration part according to claim 19, wherein a step having a height of at least 0.5 mm is produced in a front-side region of the material interface.

21. The vehicle decoration part according to claim 17, wherein the part component produced from the first plastics component is provided on a front side with a protective layer composite consisting of at least one lacquer layer.

22. The vehicle decoration part according to claim 17, wherein the contour light region is provided on a front side with a protective layer composite consisting of at least one lacquer layer.

23. The vehicle decoration part according to claim 21, wherein a first lacquer layer consists of an adhesion-promoting transparent or colored translucent material, which is applied without a further interlayer onto at least one of the part component produced from the first plastics component or onto the contour light region.

24. The vehicle decoration part according to claim 23, wherein a second lacquer layer consists of a transparent, mechanically resistant, and chemically resistant material.

25. The vehicle decoration part according to claim 19, wherein a composite consisting of the part component produced from the first plastics component and the part component produced from the second plastics component is produced by an adhesive bond or a welded connection to an internal piece carrier.

26. A method for producing a vehicle decoration part having a contour light, the decoration part being produced as a materially bonded composite from at least two plastics components in a multicomponent injection-molding method, a first plastics component of the at least two plastics components consisting of a material which can be galvanically coated or lacquered and forming the decoration part, and a second plastics component of the at least two plastics components consisting of a transparent or translucent and galvanically inert material and forming a contour light region through which light from an optical waveguide element can pass, the second plastics component being arranged on a rear side of the first plastics component, adjacent to the first plastics component, and partially covering the rear side of the first plastics component, wherein a part component produced from the first plastics component performs fastening and fixing of the optical waveguide element arranged on the rear side, the method comprising:
establishing a connection between the first plastics component and the second plastics component in the multicomponent injection-molding method;
galvanizing or lacquering a composite produced in establishing the connection, a galvanic layer or lacquer layer being formed only on the first plastics component; and
carrying out a front-side surface treatment of the galvanized or lacquered composite.

27. The method according to claim 26, wherein the surface treatment comprises an activation of the front-side surface in a plasma system with a low-pressure plasma.

28. The method according to claim 27, wherein the surface treatment comprises an activation of the front-side surface in the plasma system with a reduced pressure of 0.15 mbar and water vapor as a process gas.

29. The method according to claim 26, wherein the surface treatment comprises providing the part component produced from the first plastics component with a protective layer composite consisting of at least one lacquer layer on a front side.

30. The method according to claim 26, wherein the surface treatment comprises providing the contour light region with a protective layer composite consisting of at least one lacquer layer on a front side.

31. The method according to claim 29, wherein a first lacquer layer consisting of an adhesion-promoting transparent or colored translucent material is applied on the front side onto the galvanized or lacquered composite, without a further interlayer onto at least one of the part component produced from the first plastics component or onto the contour light region.

32. The method according to claim 31, wherein a second lacquer layer consisting of a transparent, mechanically resistant, and chemically resistant material is applied on the front side onto the galvanized or lacquered composite.
